(19) United States
(12) Patent Application Publication
(10) Pub. No.: US 2025/0119871 A1
(43) Pub. Date: Apr. 10, 2025

(54) APPARATUS AND METHOD FOR A SENSING SERVICE IN A WIRELESS NETWORK

(71) Applicant: Lenovo (Singapore) Pte. Ltd., Singapore (SG)

(72) Inventors: Genadi Velev, Darmstadt (DE); Seyedomid Taghizadeh Motlagh, Oberursel (DE); Prateek Basu Mallick, Dreieich (DE)

(21) Appl. No.: 18/907,019

(22) Filed: Oct. 4, 2024

Related U.S. Application Data
(60) Provisional application No. 63/588,648, filed on Oct. 6, 2023.

(51) Int. Cl. H04W 68/02; H04W 4/38; H04W 76/10

(52) U.S. Cl. CPC H04W 68/02; H04W 4/38; H04W 76/10

(57) ABSTRACT

Various aspects of the present disclosure relate to: receiving a paging message for a sensing service, wherein the paging message comprises sensing service information; determining whether to reply to the paging message based in part on whether the UE is configured to participate in the sensing service; and transmitting a service request message comprising an indication that the service request message is a response to the paging message for the sensing service.

### TECHNICAL FIELD

The present disclosure relates to wireless communications, and more specifically to a sensing service in a wireless network.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some implementations of the method and apparatuses described herein may further include: receiving a paging message for a sensing service, wherein the paging message comprises sensing service information; determining whether to reply to the paging message based in part on whether the UE is configured to participate in the sensing service; and transmitting a service request message comprising an indication that the service request message is a response to the paging message for the sensing service.

### BRIEF DESCRIPTION OF THE DRAWINGS

FIG. 1 illustrates an example of a wireless communications system in accordance with aspects of the present disclosure.

FIG. 2 illustrates an example of a system for sensing an object in accordance with aspects of the present disclosure.

FIG. 3 illustrates an example of a sensing system having a sensing function in accordance with aspects of the present disclosure.

FIG. 4 illustrates an example of a sensing procedure in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a network equipment (NE) in accordance with aspects of the present disclosure.

FIG. 8 illustrates a flowchart of a method performed by a UE in accordance with aspects of the present disclosure.

FIG. 9 illustrates a flowchart of a method performed by a NE in accordance with aspects of the present disclosure.

### DETAILED DESCRIPTION

Various aspects of the present disclosure relate to a system that supports a sensing service. In some cases, wireless sensing technologies may be used to acquire information about a remote object or its environment and its characteristics without physically contacting it. This can be achieved by using a camera (e.g., optical camera, thermal camera, night vision camera, and so forth) or radar sensing. Communication technologies (e.g., 3GPP specified LTE, new radio (NR), or wireless local area network (WLAN)) can also be used for sensing.

In some configurations, cellular wireless communication systems, e.g., 5GS as specified by 3GPP, may be used for wireless sensing. Specifically, a wireless system can perform a sensing task and report the results to an application, customer, or vertical (or to a generic sensing consumer) that is interested in the sensing result. The sensing may be also used internally in the wireless communication system (e.g., in a control or management plane) to improve network performance.

A radio sensing procedure may obtain environment information by: 1) transmission of a sensing signal, e.g., a sensing RS, from an AN such as a base station or a UE—the AN node may be called a sensing transmitter, e.g., sensing transmitter (TX) node; 2) reception of the reflections and/or echoes of the transmitted sensing radio signal from the environment by one or more AN nodes or UEs—such nodes can be called sensing receivers, e.g., sensing receiver (RX) node—the received sensing signals (e.g., reflections, refractions, and inferring relevant information from the environment or an object) may be called sensing data and/or measurement data; and 3) the received sensing data and/or measurement data may be processed in the network, e.g., in the RAN or in a sensing function in a core network. Based on this processing, a sensing result may be calculated. The sensing result may be used by the mobile network or may be provided to a vertical or application of the sensing consumer.

Aspects of the present disclosure are described in the context of a wireless communications system.

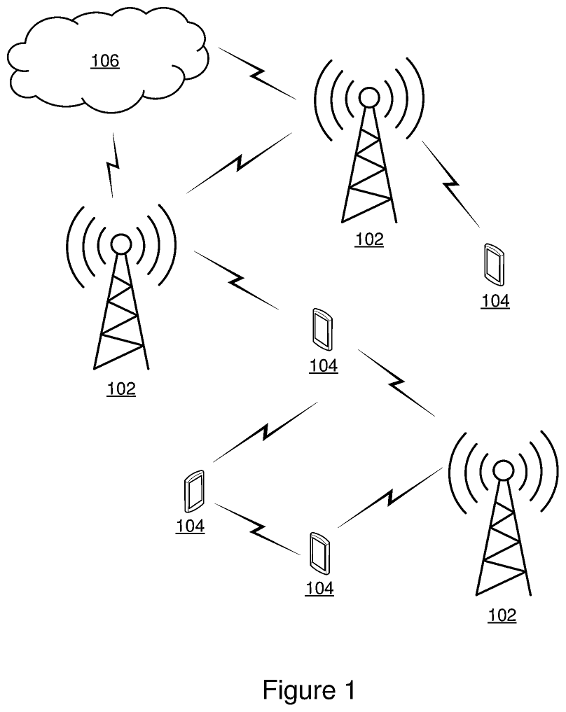

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

To implement sensing procedures, a RAN may initiate paging for sensing, and a UE may respond to the paging for sensing initiating. The NE 102 and/or UE 104 may execute a set of instructions to perform the described functions.

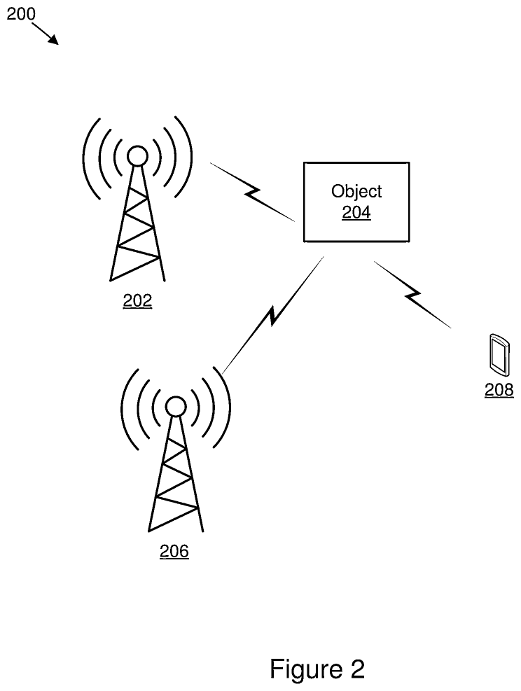

FIG. 2 illustrates an example of a system 200 for sensing an object in accordance with aspects of the present disclosure. The system 200 shows one embodiment of object sensing. In the system 200, reflected signals are received by a first gNB 202 (e.g., sensing RX) after being reflected by an object 204. Moreover, a second gNB 206 (e.g., sensing TX/RX) transmits sensing reference signal (RS) toward the object 204 and receives reflected signals from the object 204. Further, a UE 208 (e.g., sensing RX) receives reflected signals reflected by the object 204. The received sensing signal by the first gNB 202, the second gNB 206, and the UE 208 may be combined and/or sensing measurement data may be derived. The sensing measurement data may be further processed to create a sensing result.

The object 204 (e.g., sensing object) may be: 1) a passive object, e.g., an object which is not registered with the mobile network or cannot report sensing measurement to the network; or 2) an active object, e.g., the object is equipped with a UE which is capable of receiving the sensing RS and reporting the measurement to the network.

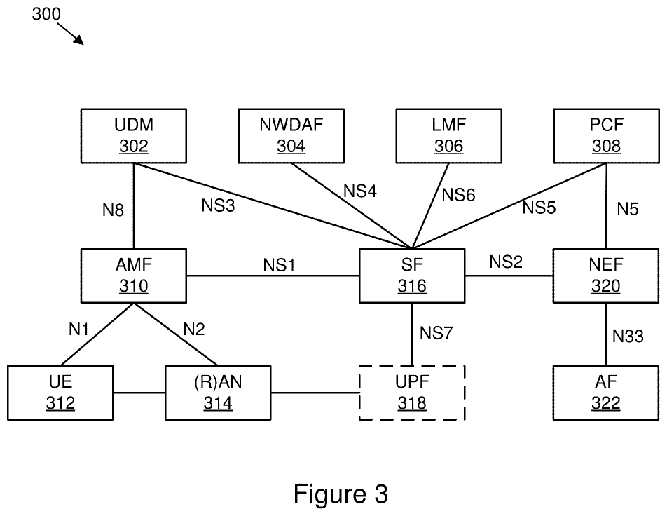

FIG. 3 illustrates an example of a sensing system 300 having a sensing function in accordance with aspects of the present disclosure. The sensing system 300 is located in a CN and includes a UDM 302, a network data analytics function (NWDAF) 304, a location management function (LMF) 306, a policy control function (PCF) 308, an AMF 310, a UE 312, a radio access network (RAN) 314, a sensing function (SF) 316, a UPF 318, a network exposure function (NEF) 320, and an AF 322. Network interfaces are labeled as “NSx”, where the x is a number, e.g., from 1 to 7, and NS means network interface for sensing.

In certain configurations, a sensing consumer is represented by an AF 322. The AF 322 may send a sensing request to a 5G system (5GS) via the NEF 520. The NEF 520 forwards the sensing request to a SF 316. The sensing request may contain a sensing task identifier (ID) (e.g., an identifier for a particular request to identify a sensing task), sensing target area, sensing object, various sensing parameters related to the sensing task, and/or other elements.

The SF 316 configures a sensing task in an access network (AN) or RAN 314 or in the UE 312. In other words, the SF 316, the RAN 314, and/or the UE 312 perform the sensing operation for the sensing task in the sensing target area. The UE 312, which is capable of sensing, may be capable of performing sensing radio signal transmission and/or reception (or measurement) according to a sensing task description.

In certain configurations, the RAN 314, which has to perform a sensing task, decides to perform sensing measurement but there are not enough devices (e.g., UEs) in a connected state to assist with radio sensing measurements. Therefore, the RAN 314 may determine to discover UEs, which are currently in radio resource control (RRC)-Inactive state or Idle state, in an area of interest. For such purpose, the RAN 314 may perform RAN-initiated paging.

If the RAN 314 needs to discover available UEs capable of or interested in a specific service (e.g., a sensing task), wherein the UEs are: 1) currently in an Idle state; 2) in a sensing target area; and 3) capable of (or interested in) a service (e.g., sensing), the RAN 314 may initiate paging for such UEs. Since this is RAN initiated paging, when the UEs respond to the paging, there may be no means for the RAN 314 to know whether the UEs are trustful (i.e., not malicious UEs), what the radio capabilities of such UEs are, and whether the UEs are authorized to perform sensing measurements. Therefore, if there is RAN initiated paging for discovery of sensing capable UEs, it may be unknown how the RAN 314 may verify that the UEs responding to the paging are eligible to participate in the sensing operation. It should be noted that the sensing service is just one example of a service for which the RAN 314 may initiate paging. There can be other services, e.g., V2X communication, for which a specific type of UEs in an Idle state (or an RRC-Inactive state) may need to be reached by the RAN 314, and therefore, the RAN 314 initiates the paging.

In some communication systems, the following paging mechanisms exist: 1) the paging for a specific UE in an Idle state is initiated by a CN; 2) the paging for a specific UE in an RRC-Inactive state is initiated by the RAN 314; 3) the paging for any UE for a specific broadcast service (e.g., for a public warning system (PWS), like earthquake and tsunami warning system (ETWS)) is initiated by the RAN 314 after RAN 314 broadcast information has been provisioned with the service—in such paging, the UEs do not initiate RRC connection establishment, but instead only reading further cell broadcast information (e.g., system information broadcast (SIB)); and/or 4) for multicast and/or broadcast services (MBS), the UEs which join an MBS session are configured to monitor the paging channel for group notifications containing an MBS session ID. The RAN 314 that supports MBS uses a group notification mechanism to notify the UEs in RRC_INACTIVE or IDLE states when the MBS session is already activated and the RAN 314 has MBS data to deliver. Upon reception of the group notification, the UEs reconnect to the network or resume the connection and transition to the RRC_CONNECTED state. The group notification is addressed with paging (P)-radio network temporary identifier (RNTI) on physical downlink control channel (PDCCH), and the paging channels are monitored by the UE 312. The paging message for group notification contains an MBS session ID which is used to page all UEs in RRC_IDLE and RRC_INACTIVE states that have joined the associated MBS multicast session, e.g., UEs are not paged individually.

In such communication systems, if the UE 312 receives a network initiated paging for MBS, the UE 312 performs a service request procedure with a transmission to the AMF 310 indicating that a PDU session associated with the MBS is to be activated. The service request message contains a “List Of PDU Sessions To Be Activated” parameter which indicates PDU session IDs of the PDU sessions which are to be activated. The AMF 310 notifies an session management function (SMF) of this PDU session and the SMF provides the MBS session information indicating that the UE 312 joined the MBS session to the RAN 314 in the N2 SM container for the associated PDU session.

In some communication systems, the UE 312 doesn't have a PDU session associated with the sensing service. Since the UE 312 doesn't transmit the sensing data to the CN (but instead transmits radio sensing measurements or sensing data to the controlling RAN 314), there is no associated PDU session established for this particular sensing service with the UE 312. Therefore, the UE 312 cannot indicate a “List Of PDU Sessions To Be Activated” to the AMF 310. In such systems, it may be unknown how the UE 312 can perform a service request procedure triggered by RAN-initiated paging for a service (e.g., sensing) without a corresponding PDU session. Furthermore, if the UE 312 in an Idle state would respond to the RAN 314 paging only by RRC connection establishment, then there may be no means in the RAN 314 to verify the UE 312, e.g., whether the UEs can be trusted and are authenticated to perform sensing measurements.

In various communication systems, the RAN 314 (e.g., gNB or another access network node) is requested to perform a sensing task. To perform such a sensing task, the RAN 314 may determine that it needs to discover UEs capable of a sensing operation (e.g., acting as a sensing transmitter, a sensing receiver, or both) which may assist in performance of the sensing task. While the RAN 314 may be aware only of the UEs in a connected state and knows their exact location and radio capabilities, the RAN 314 may not be aware of any UEs in an Idle or RRC-Inactive state which may be located in the target sensing area. Therefore, the RAN 314 may initiate paging to discover the sensing capable UEs located in the target sensing area.

The UE 312, after receiving the paging for sensing service, initiates a NAS service request procedure for the purpose to assist in the sensing operation without having to transmit user data or signaling to the network or without having been paged from the CN. In other words, the UE 312 initiates the service request procedure with a transmission to the CN for the purpose of transitioning to a connected state and assisting in the paging operation.

In various configurations, the UE 312 in an Idle state is configured to monitor specific radio resources where paging for sensing may be transmitted. The UE configuration may be general for any sensing task and may be provided to the UE 312 during a registration procedure or during RRC connection reconfiguration (e.g., if the UE 312 was in an RRC connected state). When the UE 312 receives a paging for sensing, the AS layer in the UE 312 forwards the paging message to the NAS layer. The paging message for sensing may include further information related to the sensing task, e.g., requested sensing device type, sensing task type, and/or sensing task ID. The NAS layer may verify whether the UE 312 is authorized to perform sensing in this area (e.g., identified by a cell ID or tracking area identity (TAI)). The NAS layer in the UE 312 initiates a service request procedure as a response to the paging for sensing if the NAS layer determines that the UE 312 should respond to the paging for sensing, the NAS layer initiates RRC connection establishment. A new RRC establishment cause may be used to indicate that the RRC connection is established as a response to the paging for sensing. The UE 312 may send a NAS service request message including an indication that the service request is a response to RAN initiated paging for sensing.

In some configurations, the RAN 314 is able to process a new RRC establishment cause (e.g., indicating that the RRC connection is established as response to the paging for sensing) and able to correlate the RRC connection establishment with a previous RAN initiated paging for sensing. The RAN 314 may include N2 parameters transmitted to the AMF 310 which may include sensing related information, such as a sensing task ID. Moreover, the RAN 314 may receive a UE context including sensing related information (e.g., allowed sensing area for the UE 312, the UE 312 is allowed to act as a sensing receiver, a sensing transmitter, or both).

In certain configurations, the AMF 310 is capable of: 1) the AMF 310 may receive, from the RAN 314, enhanced N2 parameters including sensing-related information (e.g., sensing task ID, and so forth) and, from the UE service request message, an indication that the service request is a response to RAN initiated paging for sensing; 2) the AMF 310 may determine whether the UE 312 is allowed to participate in the sensing operation; and/or 3) the AMF 310 transmits to the RAN 314, in the N2 message, the UE context including sensing related information (e.g., allowed sensing area for the UE 312, the UE 312 is allowed to act as a sensing receiver, a sensing transmitter, or both).

It should be noted that, as used herein, the term “Idle state” refers to RRC Idle state or to evolved packet system (EPS) connection management (CM) (ECM) and/or CM Idle state. Moreover, the term “Connected state” refers to RRC Connected state or to ECM and/or CM Connected state. Further, the term “RAN” or “RAN node” is meant to indicate any type of base station on the network side which communicates with the device, e.g., eNB as used in 4G, gNB as used in 5G, or any future generation mobile network technology. Moreover, the term “AMF” of other network function (NF) names are used for exemplary purpose and the NFs may include entities from other past or future network generations.

It should also be noted that the use of “sensing” is only one example of a service for which the embodiments herein may apply. In general, RAN-initiated paging to discover UEs (e.g., in Idle or RRC-Inactive states) for a particular service or UEs supporting particular capabilities may be applied for any other service (e.g., RAN-initiated service) such as V2X or location services.

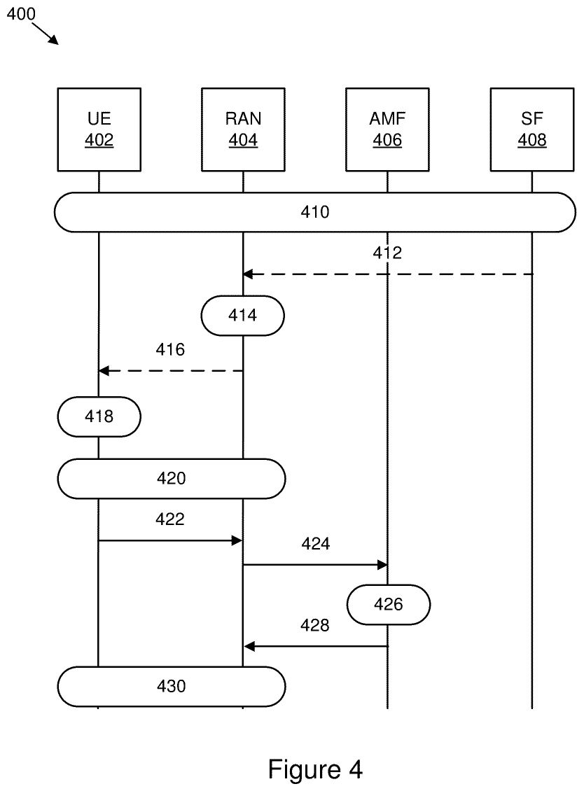

FIG. 4 illustrates an example of a sensing procedure 400 in accordance with aspects of the present disclosure. The sensing procedure 400 may implement or be implemented by one or more aspects of the wireless communications system 100. The sensing procedure 400 may include a UE 402, a RAN 404, an AMF 406, and a SF 408. The operations between the UE 402, the RAN 404, the AMF 406, and the SF 408 may occur in a different order or at different times than as shown. Some operations may also be omitted from the sensing procedure 400, and other operations may be added to the sensing procedure 400.

In the example of FIG. 4, the RAN 404 may initiate a paging request for a sensing service. The UE 402 may transmit a response corresponding to the paging request for the sensing service. Additionally, or alternatively, the UE 402 may transmit information indicating its sensing abilities.

At 410, the UE 402 may perform a registration procedure with a network. Additionally, at 410, or during a subsequent UE configuration update (UCU) procedure, the network (e.g., AMF or SF) may configure the UE 402 with an information related enablement corresponding to the sensing service (e.g., sensing configuration information). The information may indicate where and/or how the UE 402 is allowed to participate in a sensing service, or which sensing services the UE 402 is allowed to participate in.

For example, at 410, the AMF 406 may use a registration accept message or a configuration update command message to transmit sensing configuration information to the UE 402. Alternatively, at 410, the SF 408 may transmit sensing configuration information to the UE 402. The sensing configuration information may contain: 1) one or more location areas where the UE 402 is allowed, or alternatively forbidden, to participate in a sensing service; 2) a sensing type, such as a sensing transmitter or sensing receiver, that the UE 402 is allowed to apply; and/or 3) allowed sensing service types, such as sensing of particular radar cross section (RCS) types (such as large objects), non-human objects, and so forth.

Furthermore, at 410, the RAN 404 may configure the UE 402 with paging resources to be monitored by the UE 402. Alternatively, or in addition, the RAN 404 may configure the UE 402 during releasing an RRC connection when the UE 402 is transferred to an RRC-Inactive or an RRC-Idle state.

At 412, the SF 408 may request that the RAN 404 perform a sensing task. The request may include a description of the sensing task which may include a sensing task ID, sensing object information (e.g., a RCS), a sensing target area, sensing reporting information, and so forth. The SF 408 may be responsible for the sensing task. Alternatively, at 412, a core network device may send the request to the RAN 404 to request that the sensing task be performed.

Moreover, at 414, the RAN 404 may determine that it needs to discover UEs capable of sensing radio measurements which should assist in performance of the sensing task. The potential UEs may be located in a target sensing area. Therefore, the RAN 404 may determine to transmit (e.g., RAN initiated) paging for sensing in the target sensing area. The target sensing area may be a whole cell, a part of the whole cell, or multiple cells. Further, at 414, the RAN 404 may determine that it is interested in discovering UEs that are capable of acting as sensing transmitter, sensing receiver, or both. Such information may be included in a paging message for sensing.

At 416, the RAN 404 may transmit the paging message for sensing in the target sensing area. Additionally, at 416, the RAN 404 may include, in the paging message for sensing, parameters such as: a requested sensing device type for the sensing task (e.g., sensing transmitter or sensing receiver), a sensing task type (e.g., sensing objects with small or big RCS, sensing accuracy, and so forth), and/or a sensing task ID. Such parameters may be derived based on the sensing task request received at 412.

Moreover, at 418, the UE 402 (or UEs), which is capable of participating in the sensing operation (e.g., capable to operate as sensing transmitter or sensing receiver) and is configured to participate in sensing measurements, may be configured to monitor the radio resources where the paging for sensing (or other service) may be transmitted.

At 418, if a UE 402 in an Idle state receives the paging message for sensing, an AS layer in the UE 402 forwards the paging for sensing to an NAS layer. Further, at 418, if a UE 402 in an RRC-Inactive state receives the paging message for sensing, the AS layer in the UE 402 performs the following: 1) internally determines whether the UE 402 is allowed to participate in the sensing service; and 2) initiates a resume procedure using the stored AS context in the UE 402. Alternatively, at 418, the AS layer in the UE 402 may request that the NAS layer authorize participating in the sensing service. Once the AS layer in the UE 402 determines to reply positively, the UE 402 performs a resume procedure. Additionally, an anchor RAN node (e.g., gNB where the UE's AS context is stored) is able to authenticate the UE 402, and based on the stored AS context, the sensing RAN node (which can be the anchor RAN node or a new RAN node) may configure the UE 402 to perform radio sensing measurements.

Moreover, at 418, if a UE 402 is in an Idle state UE, the NAS layer may determine whether the UE 402 should respond to the paging request based on at least one of the following: 1) whether the UE 402 is authorized to participate in sensing measurement in a current UE location (e.g., in a current cell ID or TA ID); 2) whether the UE 402 is capable of acting according the requested sensing device type (e.g., sensing transmitter, sensing receiver, or both); or 3) whether the sensing task type or ID (if included in the RAN paging message) is configured in the UE 402.

At 418, if an internal verification in the UE 402 is positive, the UE 402 creates a NAS service request message as a response to the paging for sensing request. The NAS service request message includes an indication that the NAS service request is a response to the paging for sensing request.

At 420, the UE 402 may initiate an RRC connection establishment procedure. Additionally, at 420, the UE 402 may use either an existing establishment cause (e.g., mobile terminated (MT) signaling), or a new establishment cause indicating that the RRC connection is a response to the paging for sensing request. Further, at 420, the UE 402 and the RAN 404 may exchange RRC messages 1 to 4: 1) Msg #1 (from UE to RAN): random access channel (RACH)/physical RACH (PRACH) request; 2) Msg #2 (from RAN to UE): RACH response including a random access response (RAR), downlink shared channel (DL-SCH), random access (RA)-RNTI; 3) Msg #3 (from UE to RAN): RRC connection request (e.g., in bearer SRB0) with establishment cause-a new RRC establishment cause may be used to indicate that the RRC connection is established as a response to the paging for sensing; and 4) Msg #4 (from RAN to UE): RRC connection setup (e.g., in bearer SRB0).

Moreover, at 422, the UE may transmit an RRC message #5 (e.g., RRC connection setup complete message) which includes the NAS service request message. The NAS service request message may include an indication that the service request is a response to the paging for sensing request. Further, at 422, the NAS service request message may be transmitted to the CN (e.g., AMF 406) which may have the purpose to transition the UE 402 to a connected state and establish an AS context in the RAN 404 to assist completion of the sensing operation by the RAN 404. The NAS service request message may not include information for activating a PDU session (e.g., a list of PDU sessions to be activated is not included or empty).

At 424, the RAN 404 may create an N2 message including N2 parameters and the service request received at 422 and send the N2 message to the AMF 406. Further, at 424, the RAN 404 may correlate that the RRC connection establishment from the UE 402 is associated with the paging for sensing request. Based on this, the RAN 404 may include, in the N2 parameters, the sensing task ID (or other information related to the sensing service) corresponding to the sensing task from 412. This additional N2 parameter information may be used in the core network (e.g., AMF 406) to authenticate the UE 402 for participating in the sensing service.

Further, at 426, the AMF 406 receives the N2 parameters and the service request message and verifies the NAS security. If the NAS security check is successfully passed, the AMF 406, e.g., based on the indication that the service request is for sensing purpose, may verify whether the UE 402 is authorized for a sensing operation. The verification may be based on: 1) whether the UE 402 is authorized for the particular sensing task ID; and 2) whether the UE 402 is allowed to perform sensing in the particular location. The verification may be based on further criteria. The task ID and/or current UE location may be received in the N2 parameters from the RAN 404.

Moreover, at 426, the AMF 406 may exchange signaling with the SF 408 which is responsible for the sensing task. The AMF 406 may either store an SF ID in a UE context, or the AMF 406 may discover the SF 408 based on the sensing task ID received at 424.

Further, at 426, if the AMF 406 determines that the UE 402 is allowed to participate in the sensing operation in the RAN 404, the AMF 406 transmits the UE AS context to the RAN 404. The AMF 406 may also determine to keep the UE 402 in a connected state (e.g., CM-Connected state) even though there is no PDU session activated in a user plane or control plane. Additionally, the AMF 406 may rely on the RAN 404 to initiate release of the AS context of the UE 402 to transfer the UE 402 to the Idle state, e.g., when the UE 402 does not need to participate any longer in the sensing operation.

At 428, a N2 request message is transmitted and includes: a security context, a radio capability, a mobility restriction list for the UE 402, list of recommended cells/TAs/next generation (NG)-RAN node identifiers, and/or sensing-related information. The sensing-related information may include: an authorization area (e.g., list of cell or TA identifier) where the UE 402 is allowed to perform the sensing operation and/or further UE 402 sensing information based on the UE 402 subscription type (e.g., subscribed to act as sensing receiver, sensing transmitter, or both) or based on the UE 402 registration for the sensing service at the SF 408.

Moreover, at 430, the RAN 404 may perform an RRC connection reconfiguration procedure which may include the security context establishment and may configure the UE 402 to perform and report sensing measurements for the sensing task. Further, at 430, sensing measurement data, sensing configuration, and/or synchronization data may be transmitted between the UE 402 and the RAN 404 may be transmitted over the a SRB2 bearer.

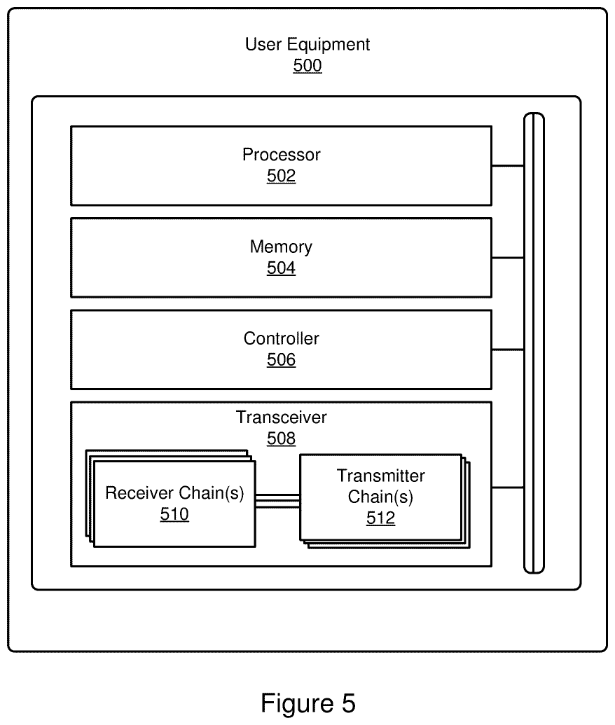

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

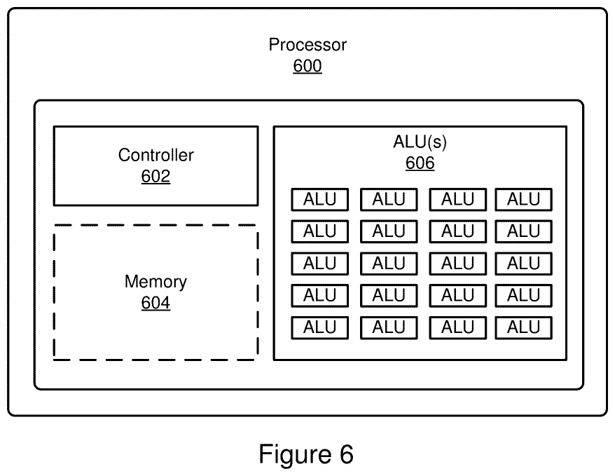

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for: receiving a paging message for a sensing service, wherein the paging message comprises sensing service information; determining whether to reply to the paging message based in part on whether the UE is configured to participate in the sensing service; and transmitting a service request message comprising an indication that the service request message is a response to the paging message for the sensing service.

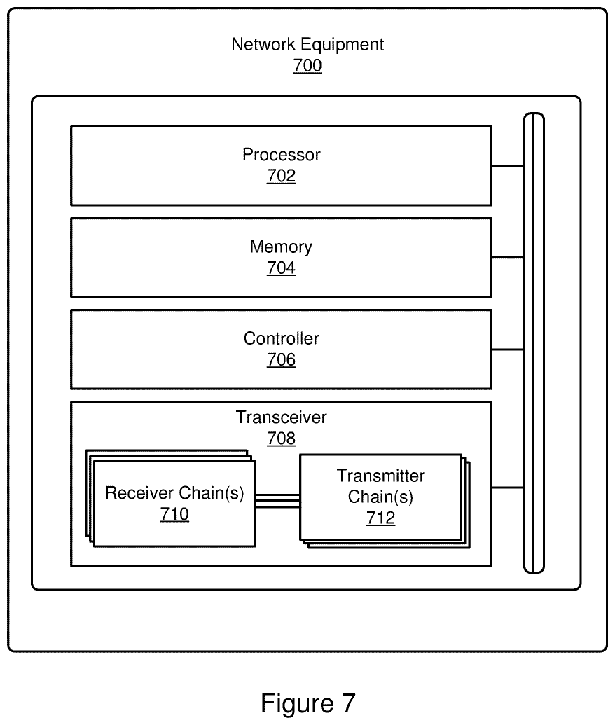

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to support a means for: receiving a service request message corresponding to a user equipment (UE), wherein the service request message comprises an indication that the service request message is a response to a paging message for a sensing service; determining whether the UE is allowed to participate in the sensing service; and sending a response message indicating whether the UE is allowed to participate in the sensing service.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

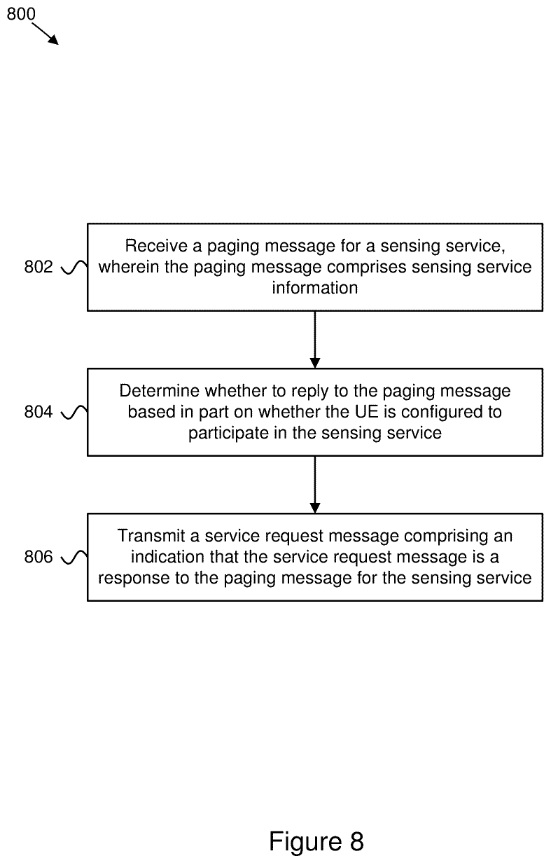

FIG. 8 illustrates a flowchart of a method 800 in accordance with aspects of the present disclosure. The operations of the method 800 may be implemented by a UE as described herein. In some implementations, the UE may execute a set of instructions to control the function elements of the UE to perform the described functions.

At 802, the method may include receiving a paging message for a sensing service, wherein the paging message comprises sensing service information. The operations of 802 may be performed in accordance with examples as described herein. In some implementations, aspects of the operations of 802 may be performed by a UE as described with reference to FIG. 5.

At 804, the method may include determining whether to reply to the paging message based in part on whether the UE is configured to participate in the sensing service. The operations of 804 may be performed in accordance with examples as described herein. In some implementations, aspects of the operations of 804 may be performed by a UE as described with reference to FIG. 5.

At 806, the method may include transmitting a service request message comprising an indication that the service request message is a response to the paging message for the sensing service. The operations of 806 may be performed in accordance with examples as described herein. In some implementations, aspects of the operations of 806 may be performed a UE as described with reference to FIG. 5.

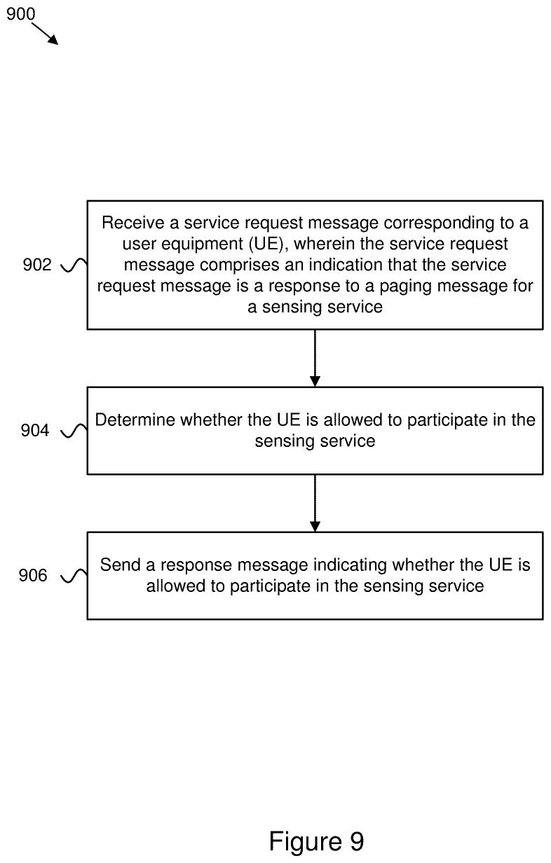

FIG. 9 illustrates a flowchart of a method 900 in accordance with aspects of the present disclosure. The operations of the method 900 may be implemented by a NE as described herein. In some implementations, the NE may execute a set of instructions to control the function elements of the NE to perform the described functions.

At 902, the method may include receiving a service request message corresponding to a user equipment (UE), wherein the service request message comprises an indication that the service request message is a response to a paging message for a sensing service. The operations of 902 may be performed in accordance with examples as described herein. In some implementations, aspects of the operations of 902 may be performed by a NE as described with reference to FIG. 7.

At 904, the method may include determining whether the UE is allowed to participate in the sensing service. The operations of 904 may be performed in accordance with examples as described herein. In some implementations, aspects of the operations of 904 may be performed by a NE as described with reference to FIG. 7.

At 906, the method may include sending a response message indicating whether the UE is allowed to participate in the sensing service. The operations of 906 may be performed in accordance with examples as described herein. In some implementations, aspects of the operations of 906 may be performed a NE as described with reference to FIG. 7.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one memory; and
at least one processor coupled with the at least one memory and configured to cause the UE to:
receive a paging message for a sensing service, wherein the paging message comprises sensing service information;
determine whether to reply to the paging message based in part on whether the UE is configured to participate in the sensing service; and
transmit a service request message comprising an indication that the service request message is a response to the paging message for the sensing service.

2. The UE of claim 1, wherein the at least one processor is configured to cause the UE to store sensing service configuration information comprising radio resources for the paging message, permission to participate in the sensing service, or a combination thereof.

3. The UE of claim 2, wherein the radio resources are stored in an access stratum (AS) layer and are received from a radio access network (RAN).

4. The UE of claim 2, wherein information corresponding to the permission to participate in the sensing service is stored at a non-access stratum (NAS) layer received from a core network device.

5. The UE of claim 2, wherein the at least one processor is configured to cause the UE to determine, based on the stored sensing service configuration information and the received sensing service information in the paging message, whether the UE is allowed to participate in the sensing service in a current location, for a sensing task type, for a sensing task identifier (ID), or a combination thereof.

6. The UE of claim 1, wherein the sensing service information in the paging message comprises a requested sensing device type, a sensing task type, a sensing task identifier (ID), or a combination thereof.

7. The UE of claim 1, wherein the at least one processor is configured to cause the UE to establish a radio resource control (RRC) connection with an RRC establishment cause indicating that the RRC connection is established in response to the paging message.

8. The UE of claim 1, wherein the paging message is received from a radio access network (RAN).

9. The UE of claim 1, wherein the service request message is transmitted to a radio access network (RAN).

10. A processor for wireless communication, comprising:
at least one controller coupled with at least one memory and configured to cause the processor to:
receive a paging message for a sensing service, wherein the paging message comprises sensing service information;
determine whether to reply to the paging message based in part on whether the processor is configured to participate in the sensing service; and
transmit a service request message comprising an indication that the service request message is a response to the paging message for the sensing service.

11. The processor of claim 10, wherein the at least one controller is configured to cause the processor to store sensing service configuration information comprising radio resources for the paging message, permission to participate in the sensing service, or a combination thereof.

12. The processor of claim 11, wherein the radio resources are stored in an access stratum (AS) layer and are received from a radio access network (RAN).

13. The processor of claim 11, wherein information corresponding to the permission to participate in the sensing service is stored at a non-access stratum (NAS) layer received from a core network device.

14. A method performed by a user equipment (UE), the method comprising:
receiving a paging message for a sensing service, wherein the paging message comprises sensing service information;
determining whether to reply to the paging message based in part on whether the UE is configured to participate in the sensing service; and
transmitting a service request message comprising an indication that the service request message is a response to the paging message for the sensing service.

15. An apparatus for performing a first network function, the apparatus comprising:
at least one memory; and
at least one processor coupled with the at least one memory and configured to cause the apparatus to:
receive a service request message corresponding to a user equipment (UE), wherein the service request message comprises an indication that the service request message is a response to a paging message for a sensing service;
determine whether the UE is allowed to participate in the sensing service; and
send a response message indicating whether the UE is allowed to participate in the sensing service.

16. The apparatus of claim 15, wherein the processor is configured to cause the apparatus to receive sensing service related information, and the sensing service related information is received together with the service request message as part of information from radio access network (RAN).

17. The apparatus of claim 15, wherein the processor is configured to cause the apparatus to exchange information with a second network function, consider sensing service related information, or a combination thereof.

18. The apparatus of claim 17, wherein the second network function comprises a sensing function (SF).

19. The apparatus of claim 15, wherein the first network function comprises an access and mobility management function (AMF).

20. The apparatus of claim 15, wherein the response message is sent to a radio access network (RAN) that transmitted the service request message.
